(19) United States
(12) Patent Application Publication
(10) Pub. No.: US 2014/0245080 A1
(43) Pub. Date: Aug. 28, 2014

(54) INTERFACE DETECTION CIRCUIT

(71) Applicants: HONG FU JIN PRECISION INDUSTRY (WuHan) CO., LTD., (US); HON HAI PRECISION INDUSTRY CO., LTD., New Taipei (TW)

(72) Inventors: YONG-ZHAO HUANG, Wuhan (CN); JIN-LIANG XIONG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/891,179

(22) Filed: May 9, 2013

(30) Foreign Application Priority Data
Feb. 26, 2013 (CN) 2013100592118

(51) Int. Cl. G06F 11/07

(52) U.S. Cl. CPC G06F 11/0745
USPC 714/48

(57) ABSTRACT

An interface detection circuit is used for detecting whether an interface of an electronic device is in good contact with an interface of a connection device. The interface detection circuit includes a pressure sensing module, a signal processing module, and a warning module. The pressure sensing module detects whether the pins of the interface of the electronic device is suffered pressure and transmits the detecting results to the signal processing module. The signal processing module magnifies and calculates the detecting results. The signal processing module outputs a control signal to the warning module. The warning module alerts the user whether the two interfaces make good contact with each other.

### BACKGROUND

1. Technical Field

The present disclosure relates to an interface detection circuit.

2. Description of Related Art

Universal serial bus (USB) and serial advanced technology attachment (SATA) are popular interface communication standards used on most electronic devices. For example, a USB device or a USB data cable with a USB interface is usually connected to a computer for transmitting data. However, when the transmission of data fails, it is difficult to estimate whether the USB interface has a poor contact with the computer or the USB device is defective, which is inconvenient.

Therefore, there is need for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of an interface detection circuit connected to an electronic device and a connection device.

FIG. 2 is a circuit diagram of the interface detection circuit of FIG. 1.

### DETAILED DESCRIPTION

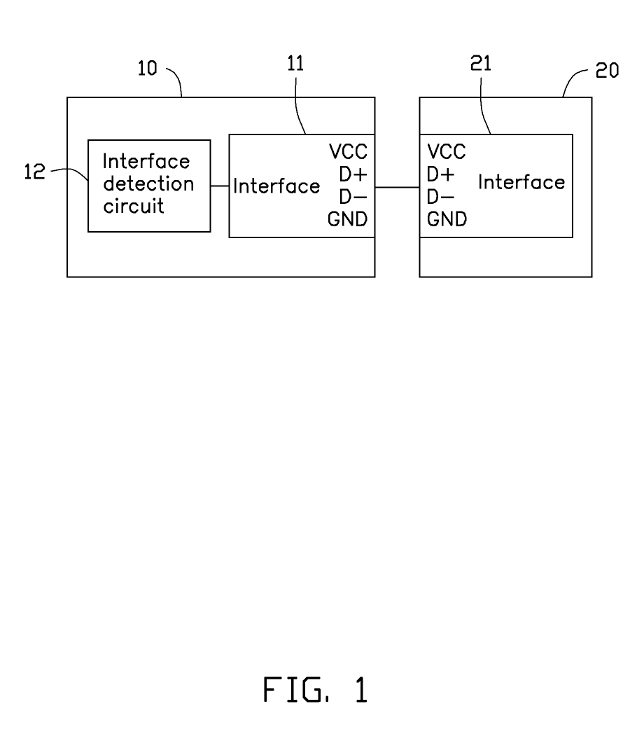

FIG. 1 shows an embodiment of an interface detection circuit 12 set inside an electronic device 10 for detecting the connection of an interface 11 of the electronic device 10 and an interface 21 of a connection device 20. Both of the interfaces 11 and 21 are universal serial bus (USB) interfaces. The interface detection circuit 12 is used for detecting and showing whether the interfaces 21 and 11 are contacted well, after each of the interfaces 21 and 11 are connected to each other.

Each of the interfaces 21 and 11 includes a power pin VCC, a first data pin D+, a second data pin D−, and a ground pin GND. In the embodiment, the electronic device 10 can be a computer or a server. The connection device 20 can be a hard disk drive or a data card.

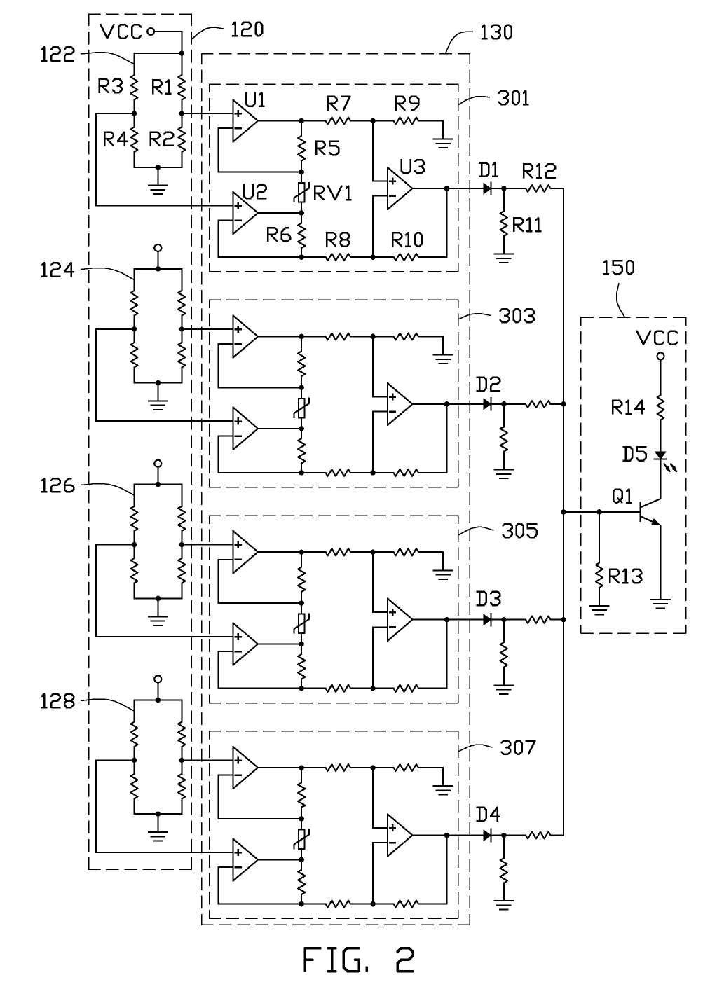

Referring to FIG. 2, the interface detection circuit 12 includes a pressure sensing module 120, a signal processing module 130, a protection module, and a warning module 150. The pressure sensing module 120 includes four bridge circuits 122, 124, 126, and 128. The signal processing module 130 includes four operation units 301, 303, 305, and 307. The protection module includes four protection switches, i.e. first to fourth diodes D1-D4.

The bridge circuit 122 is located under the power pin VCC of the interface 11 and is connected to the operation unit 301 of the signal processing module 130. The operation unit 301 is connected to the warning module 150 through the diode D1 of the protection module. The bridge circuit 124 is located under the first data pin D+ of the interface 11 and is connected to the operation unit 303. The operation unit 303 is connected to the warning module 150 through the diode D2 of the protection module. The bridge circuit 126 is located under the second data pin D− of the interface 11 and is connected to the operation unit 305. The operation unit 305 is connected to the warning module 150 through the diode D3 of the protection module. The bridge circuit 128 is located under the ground pin GND of the interface 11 and is connected to the operation unit 307. The operation unit 307 is connected to the warning module 150 through the diode D4 of the protection module.

The bridge circuit 122 includes four piezoresistors R1-R4. A first end of the piezoresistor R1 is connected to a power source VCC. A second end of the piezoresisitor R1 functions as a first output of the bridge circuit 122 and is grounded through the piezoresistor R2. A first end of the piezoresistor R3 is connected to the power source VCC. A second end of the piezoresistor R3 functions as a second output of the bridge circuit 122 and is grounded through the piezoresistor R4.

The operation unit 301 includes a first amplifier U1, a second amplifier U2, and a third amplifier U3. A non-inverting input of the first amplifier U1 is connected to the first output of the bridge circuit 122. An inverting input of the first amplifier U1 is connected to an output of the first amplifier U1 through a resistor R5. A non-inverting input of the second amplifier U2 is connected to the second output of the bridge circuit 122. An inverting input of the second amplifier U2 is connected to an output of the second amplifier U2 through a resistor R6. A non-inverting input of the third amplifier U3 is connected to the output of the first amplifier U1 through a resistor R7 and is ground by a resistor R9. An inverting input of the third amplifier U3 is connected to the inverting input of the second amplifier U2 through a resistor R8. The inverting input of the third amplifier U3 is also connected to an output of the third amplifier U3 through a resistor R10. The output of the third amplifier U3 is connected to an anode of the diode D1. A cathode of the diode D1 is grounded through a resistor R11 and is connected to the warning module 150 through a resistor R12. The operation unit 301 also includes an adjustable resistor RV1 connected between the inverting input of the amplifier U1 and the output of the amplifier U2, for regulating magnification of the first amplifier U1 and the second amplifier U2.

The warning module 150 includes a transistor Q1 and a light emitting diode (LED) D5. A base of the transistor Q1 is connected to the cathode of the diode D1 through the resistor R12 and is grounded through a resistor R13. An emitter of the transistor Q1 is grounded. A collector of the transistor Q1 is connected to a cathode of the LED D5. An anode of the LED D5 is connected to the power source VCC through a resistor R14. In one embodiment, the transistor Q1 is an npn bipolar junction transistor.

When any of the four piezoresistors R1-R4 of the bridge circuit 122 is not pressed by the power pin VCC of the interface 11, a voltage difference between the first output and the second output of the bridge circuit 122 is zero, which means the bridge circuit 122 is balanced. A voltage received by the non-inverting input of the first amplifier U1 is equal to a voltage received by the non-inverting input of the second amplifier U2. A voltage output of the first amplifier U1 is equal to a voltage output of the second amplifier U2. A voltage of the non-inverting input of the third amplifier U3 is equal to a voltage of the inverting input of the third amplifier U3. The output of the third amplifier U3 outputs a low level signal, such as logic 0.

When any of the four piezoresistors R1-R4 of the bridge 122 is pressed by the power pin VCC of the interface 11, a voltage difference between the first output and the second output of the bridge 122 is generated, which means the bridge circuit 122 is unbalanced. The resistance of the adjustable resistor RV1 is adjusted by testers when debugging or troubleshooting the interfaces at the manufacturer during production. The resistance of RV1 is adjusted to make the voltage of the non-inverting input of the third amplifier U3 greater than the voltage of the inverting input of the third amplifier U3. The output of the third amplifier U3 outputs a high level signal, such as logic 1. In the embodiment, a same phase parallel differential amplifier consisted of the first amplifier U1 and the second amplifier U2 composes a two stage amplifier circuit with the third amplifier U3. The two stage amplifier circuit can enlarge the magnification of the operation unit 301 and improve the detection precision and efficiency.

The work principle of each of the bridge circuits 124, 126, and 128 is same as the bridge circuit 122. The circuit structure and work principle of each of the operation units 303, 305, and 307 are same as the operation unit 301. The connection relationship and work principle between the diode D2 and the operation unit 303, the diode D3 and the operation unit 305, the diode D4 and the operation unit 307 are same as the diode D1 and operation unit 301.

If the interface 21 of the connection device 20 is in good contact with the interface 11 of the electronic device 10 after the interface 21 is inserted in the interface 11, each pin of the interface 11 is respectively in contact with each pin of the interface 21. The power pin VCC, the first data pin D+, the second data pin D−, and the ground pin GND of the interface 11 can get pressure respectively from the power pin VCC, the first data pin D+, the second data pin D−, and the ground pin GND of the interface 21. Each of the bridge circuits 122, 124, 126, and 128 gets pressure from the power pin VCC, the first data pin D+, the second data pin D−, and the ground pin GND of the interface 11. The output of each of the operation units 301, 303, 305, and 307 outputs a high level signal. The diodes D1-D4 are turned on. A voltage of the base of the transistor Q1 reaches a turn-on voltage of the transistor Q1. Therefore, the transistor Q1 is turned on and the LED D5 is turned on to emit light to indicate the interface 11 and the interface 21 make good contact with each other. In the embodiment, only when all the diodes D1-D4 are turned on, the voltage of the base of the transistor Q1 can reach the break-over voltage of the transistor Q1.

If the interface 21 of the connection device 20 does not contact well with the interface 11 of the electronic device 10 after the interface 21 is inserted to the interface 11, at least one of the pins of the interface 11 may not be in contact with the corresponding pin of the interface 21. For example, the power pin VCC of the interface 11 is not in contact with the power pin VCC of the interface 21. The bridge circuit 122 cannot get a pressure reading. The output of the operation unit 301 outputs a low level signal. The diode D1 is turned off. The voltage of the base of the transistor Q1 cannot reach the break-over voltage of the transistor Q1. The transistor Q1 is turned off. Therefore, the LED D5 does not emit light for showing the interface 11 has a poor contact with the interface 21.

The diodes D1-D4 can also prevent the output of any one of the operation units from outputting signals to the outputs of the other operation units.

The interface circuit 12 not only can detect the contact of the USB interfaces, but also can detect the contact of other types of interfaces, such as serial advanced technology attachment (SATA) interfaces.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An interface detection circuit for detecting whether a first interface and a second interface are in good contact with each other, the interface detection circuit comprising:
a pressure sensing module comprising a plurality of bridge circuits set under a plurality of pins of the first interface, each bridge circuit operable of sensing pressure of a plurality of pins of the second interface applied on the plurality of pins of the first interface circuit, and comprising a first output and a second output;
a signal processing module comprising a plurality of operation units each receiving output signals from the first and second outputs of the corresponding bridge circuit and outputting a control signal; and
a warning module receiving the control signal outputted by each operation unit, and showing whether the first and second interfaces make good contact with each other;
wherein each operation unit comprises a first amplifier, a second amplifier, and a third amplifier, a non-inverting input of the first amplifier is connected to the first output of a corresponding bridge circuit, a non-inverting input of the second amplifier is connected to the second output of the corresponding bridge circuit, an output of the first amplifier is connected to an inverting input of the first amplifier and a non-inverting input of the third amplifier, an output of the second amplifier is connected to an inverting input of the second amplifier and an inverting input of the third amplifier, the non-inverting input of the third amplifier is grounded through a first resistor, an output of the third amplifier is connected to the inverting input of the third amplifier, the output of the third amplifier outputs the control signal.

2. The interface detection circuit of claim 1, wherein when a bridge circuit senses a pressure from the corresponding pin, a voltage difference is formed between the first output and the second output of the bridge circuit, the third amplifier of the corresponding operation unit outputs a high level signal to the warning module; when a bridge cannot sense a pressure from the corresponding pin, a voltage difference is non-existent between the first output and the second output of the bridge circuit, the third amplifier of the corresponding operation unit outputs a low level signal to the warning module

3. The interface detection circuit of claim 2, wherein the warning module comprises an electronic switch and an indicator, a first end of the electronic switch is grounded through a second resistor and connected to the output of the third amplifier of each operation unit, a second end of the electronic switch is grounded, a third end of the electronic switch is connected to a first end of the indicator, a second end of the indicator is connected to a power source through a third resistor, when all the operation units output high level signals, the second end and the third end of the electronic switch are connected to each other, the indicator is turned on; when at least one of the operation unit outputs a low level signal, the second end and the third end of the electronic switch are disconnected from each other, the indicator is turned off.

4. The interface detection circuit of claim 3, further comprising a protection switch connected between the outputs of the third amplifiers of the operation units and the first end of the electronic switch of the warning module.

5. The interface detection circuit of claim 4, wherein the protection switch comprises a plurality of diodes, a cathode of each diode is grounded through a fourth resistor and connected to the first end of the electronic switch through a fifth resistor, an anode of each diode is connected to the output of the third amplifier of the corresponding operation unit.

6. The interface detection circuit of claim 3, wherein the electronic switch is an npn bipolar junction transistor, the first end, the second end, and the third end of the electronic switch are respectively corresponding to a base, an emitter, and a collector of the npn transistor.

7. The interface detection circuit of claim 3, wherein the indicator is a light emitting diode, the first end and the second end are respectively corresponding to a cathode and an anode of the light emitting diode.

8. The interface detection circuit of claim 1, wherein each bridge circuit comprises first to fourth piezoresistors, a first end of the first piezoresistor is connected to a power source, a second end of the piezoresistor is grounded through the second piezoresistor, a first end of the third piezoresistor is connected to the power source, a second end of the third piezoresistor is grounded through the fourth piezoresistor, the second end of the first piezoresistor functions as the first output of the bridge circuit, the second end of the third piezoresistor functions as the second output of the bridge circuit.

9. The interface detection circuit of claim 1, wherein each operation unit further comprises an adjustable resistor, the inverting input of the first amplifier is connected to a first end of the adjustable resistor, the output of the second amplifier is connected to a second end of the adjustable resistor, the output of the first amplifier is connected to the first end of the adjustable resistor through a sixth resistor and connected to the non-inverting input of the third amplifier through a seventh resistor, the inverting input of the second amplifier is connected to the second end of the adjustable resistor through an eighth resistor and connected to the inverting input of the third amplifier through a ninth resistor.
